(19) United States
(12) Patent Application Publication
(10) Pub. No.: US 2023/0365829 A1
(43) Pub. Date: Nov. 16, 2023

(54) THERMAL INSULATION COATING MATERIAL

(71) Applicant: DEXXON ENERJI SANAYI VE TICARET ANONIM SIRKETI, Istanbul (TR)

(72) Inventors: Murat KOC, Sakarya (TR); Esman ABDULAYEV, Moskova (RU)

(73) Assignee: DEXXON ENERJI SANAYI VE TICARET ANONIM SIRKETI, Istanbul (TR)

(21) Appl. No.: 18/027,929

(22) PCT Filed: Jul. 29, 2021
(86) PCT No.: PCT/TR2021/050750

§ 371 Date: Mar. 23, 2023

(30) Foreign Application Priority Data
Sep. 28, 2020 (TR) 2020/15381

(51) Int. Cl. C09D 133/08; C09D 7/61; C09D 7/65; C09D 5/33

(52) U.S. Cl. CPC C09D 133/08; C09D 7/61; C09D 7/65; C09D 5/004

(57) ABSTRACT

A coating material that provides thermal insulation of the surfaces where the coating material treats and reduces the amount of solar or other thermal energies that can affect structures in an unfavorable manner. The coating material has a water-acrylic polymer solution which provides the characteristics of the coating material with specific weight proportions in its body, hollow glass spheres in micron and/or nano-dimensions and coated with binding agents which increase the interface bond between the water-acrylic polymer solution and/or hollow glass spheres which can be used as the filling substance.

### TECHNICAL FIELD

The present invention relates to a coating material which can provide thermal insulation of the surfaces where said coating material treats and besides which can reduce the amount of solar or other thermal energies which lead to affecting of structures in an unfavorable manner.

### PRIOR ART

The access efforts to energy sources in the world are among the reasons and determiners of wars and economical and political relations between countries. Pluralities of countries, which are developed and which are developing, needs more energy when compared with the population thereof. In order to meet the energy needs which increase every passing day and in order to release from foreign-source dependence, studies on development of renewable energy sources (wind, sun) and on energy saving are accelerated.

In developed countries, thanks to the energy efficiency decisions provided after 1975s, a very big saving has been provided like 55% in the amount of energy consumed until 2005. In 1990s, more importance has been given to energy efficiency, and as a result of this, total energy consumption in the world has not increased in a parallel manner to growth and has stayed at lower proportions.

The processes realized for decreasing heat passage between two media having different temperatures are called “thermal insulation”. Thermal insulation is used for decreasing the amount of energy consumed for heating in winter and for cooling in summer and for living in a more comfortable manner and thermal insulation is the precautions which decrease heat passage which occurs at external walls of buildings, window glass and joineries, roofs, upholsteries and transmission systems. Humans need mediums at temperatures 20-22° C. in order to sustain a comfortable life. In pluralities of regions of Turkey, winter months are substantially cold and the summer months are hot. The insulation material is thick in climates having big number of cold days and the insulation material is thinner in hot regions. Thermal insulation is important not only against cold but also for protection from the hot. The cooling cost in summer is much more than the heating cost in winter. In accordance with nature rules, heat, which is a type of energy, is always transferred from the hot medium towards the cold medium. This transfer cannot be stopped but can be controlled by means of thermal insulation. Heat loss occurs as the heat, which exists in the inner section of a building, moves to the outer medium, and the heat, which exists in the outer medium, moves into the building in summer and heats the medium.

As known, the thermal insulation coating materials used in the art have specific usage durations and it is seen that aggressive medium conditions are not substantially added to the determined usage durations. In this form, coating materials have less usage durations when compared with the estimated durations.

Besides, while coating materials provide thermal insulation, they are in connection with the solar and other thermal energies and this substantially affects the structures of said materials. The materials which provide thermal insulation must be materials which are resistant to thermal energies.

Since the materials used in thermal insulation are essentially in connection with the outer medium, they must also resist to the environmental indications. Particularly for thermal coating materials, ultraviolet radiation, acid-alkali rains and corrosive media are examined as secondary reasons and the coating materials must have high resistance to said conditions.

As a result, because of the abovementioned problems and requirements, a thermal insulation coating material, which can show high resistance against external medium conditions, is required in the related technical field.

### BRIEF DESCRIPTION OF THE INVENTION

The present invention relates to a thermal insulation coating material, for eliminating the abovementioned disadvantages and for bringing new advantages to the related technical field.

An object of the present invention is to provide a coating material which provides thermal insulation of the surface where said coating material treats.

An object of the present invention is to provide a coating material which can show high resistance against aggressive environmental conditions.

An object of the present invention is to provide a coating material which decreases the amount of thermal energies which affect technological equipment and structures.

The present invention relates to a coating material which can provide thermal insulation of the surfaces where said coating material treats and besides which can decrease the amount of solar or other thermal energies which lead to affecting of the technological equipment and structures in an unfavorable manner. Accordingly, the coating material comprises water- acrylic polymer solution which provides the characteristics of the coating material with specific weight proportions in its body, hollow glass spheres which are in micron and/or nano-dimensions and which are coated with binding agents which increase the interface bond between the water-acrylic solution and/or glass spheres which can be used as the filling substance. By means of this, a coating material is obtained which can provide thermal insulation and besides which can decrease the amount of solar or other thermal energies which lead to affecting of the technological equipment and structures in an unfavorable manner.

In a possible embodiment of the present invention, the thermal insulation material comprises acrylic emulsion at a value between 35% and 45% by weight, hollow glass spheres coated with binding agents which increase interface bond between water-acrylic solution and at specific nano and/or micro dimensions at a value between 8% and 35% by weight and which provide increase of the thermal insulation characteristics and glass structures which function as filling material between 3% and 15% by weight, and water between 10% and 20% by weight. By means of this, the desired characteristics of the obtained coating material can be provided.

In a possible embodiment of the present invention, the thermal insulation material preferably comprises silicon dioxide at a value between 0.5% and 1.5% by weight, asbestos wool at a value between 2% and 5% by weight, opaque polymer component at a value between 6% and 10% by weight, talc powder at a value between 6% and 10% by weight, foam remover at a value between 0.1% and 0.5% by weight, antiseptic component at a value between 0.1% and 0.5% by weight, thinner component at a value between 0.3% and 0.6% by weight, dispenser agent at a value between 0.3% and 0.7% by weight, liquid silicon at a value between 3% and 12% by weight and polyurethane component at a value between 0.2% and 0.5% by weight. By means of this, a coating material is obtained which is elastic and which has high corrosion resistance and which is resistant to abrasion and which is thermally insulator and which is robust and which protects the insulated surface from the effects of hot, cold and air conditions in an efficient manner.

In a possible embodiment of the present invention, the dimensions of said hollow glass spheres and/or glass structure are at a value between 65 and 115 micrometers.

### DETAILED DESCRIPTION OF THE INVENTION

In this detailed description, the subject matter relates to a coating material which can provide thermal insulation of the surfaces where said coating material treats and besides which can reduce the amount of solar or other thermal energies which lead to affecting of structures in an unfavorable manner and is explained with references to examples without forming any restrictive effect only in order to make the subject more understandable.

The subject matter thermal insulation coating material is a composite material where all inputs are associated with each other when examined in general. Accordingly, the matrix component which meets the characteristics of coating material is water-acrylic dispersion mixture. As the support components which provide the desired characteristics to the structure of the coating material, glass spheres with specific nano or micron dimensions are added and/or filling components with specific weight proportions are added. By means of this, a composite coating material is obtained which provides thermal insulation and besides which can show high resistance to aggressive environmental conditions.

The thermal insulation coating material comprises water-acrylic polymer emulsion as the matrix component. As also known in the art, the water-acrylic polymer structure has characteristics like easy cleaning, high usage durations and not leading to toxic effect.

The thermal insulation coating material comprises hollow glass spheres with micron and/or nano-dimensions which provide the characteristics desired to be provided, and/or glass spheres to be used as filling substance. The hollow glass spheres provide greatening of the resin for the coating material and increasing of the volume and obtaining final product with lower weight. Glass spheres do not affect the chemical characteristic of the product where said glass spheres are added. Glass spheres provide easier placement to the mold as they increase the fluidity of the product. They provide lower viscosity. As the glass spheres are added to the coating material as support component, they provide reflection of the heat coming onto the coating material.

The interface bond between the water-acrylic polymer structure and the hollow glass spheres and glass structures, provided in the thermal insulation coating material, must be increased. During production of the hollow glass spheres, coating is realized together with binding agents. Since the hollow spheres are coated by means of binding agents, a strong interface connection can be set up by means of water-acrylic polymer structure.

The dimensions of said hollow glass spheres, provided in the thermal insulation coating material, are at a value between 65 and 115 micrometers in order to provide the desired characteristics. The hollow glass spheres are at a value between 3% and 35% by weight in the body of the thermal insulation coating material.

The thermal insulation coating material moreover comprises filling glass structures. Said filling glass structures are at a value between 3% and 15% by weight in the body of the coating material.

There are filling and support components in order to increase the characteristics of the thermal insulation coating material and in order to form a structure which can show high resistance against aggressive environmental conditions.

The coating material, which is to be obtained at specific weight proportions as said filling and/or support components, comprises silicon dioxide for providing thickening and reinforcement characteristics, asbestos wool which provides increase of resistance against heat, fire and acids, opaque polymer component which decreases the amount of binder to be used and where the scrubbing resistance and shininess are increased, talc powder which provides engagement of the paint platelets to each other and to the surface and besides which increases homogeneous appearance, and foam remover which decreases foam formation.

The thermal insulation coating material moreover comprises diluter, antiseptic component, dispenser, liquid silicon and polyurethane components with specific weight proportions.

The thermal insulation coating material obtained by means of the present invention comprises acrylic polymer component at a value between 35% and 45% by weight, hollow glass spheres which provide increase of the thermal insulation characteristics and at specific nano and/or micro dimensions at a value between 8% and 35% by weight and glass structures which function as filling material between 3% and 15% by weight, and water between 10% and 20% by weight.

The thermal insulation coating material preferably comprises silicon dioxide at a value between 0.5% and 1.5% by weight, asbestos wool at a value between 2% and 5% by weight, opaque polymer component at a value between 6% and 10% by weight, talc powder at a value between 6% and 11% by weight, foam remover at a value between 0.1% and 0.5% by weight, antiseptic component at a value between 0.1% and 0.5% by weight, thinner component at a value between 0.3% and 0.6% by weight, dispenser agent at a value between 0.3% and 0.7% by weight, liquid silicon at a value between 3% and 12% by weight and polyurethane component at a value between 0.2% and 0.5% by weight.

The thermal insulation coating material obtained by means of the present invention can be applied to the surfaces in a simple manner, and the usage of equipment like brush, roll or sprayer gun is sufficient.

The thermal insulation coating material has usage lifetime of at least 10 years.

The thermal insulation coating material decreases the thermal energy amount, coming from the environment, by at least 70%.

The thermal insulation coating material is a reliable material in case of a fire since it has components which show resistance to heat at high degrees.

The obtained thermal insulation coating material can be used in the thermal insulation of air-conditioning systems and cooling units, in insulation of units and equipments having complex structure where traditional materials cannot be used, in prevention of condensation in metal structures, in protection of steel and cast surfaces which are subjected to high temperatures, in reduction of high temperatures in hot workshops, in thermal insulation and corrosion protection in various pipe lines, in thermal insulation of metal shade and roofs, in thermal insulation of metal structures, in reduction of the temperature to a suitable level for humans in thermal unit plants, in protection of tanks and reservoirs from the effects of solar rays, low temperatures and corrosion, in reduction of thermal loss from roof structures of buildings, in thermal insulation and corrosion protection of petrol and gas pipe lines, and in providing thermal and noise insulation of carrier vehicles.

TABLE 1
Comparison of the temperature of the surface without coating and
the temperature of the surface where coating material is applied

MATERIAL
SURFACE

| (METAL) | SURFACE TEMPERATURE ° C. | | | |
|---|---|---|---|---|
| SURFACE | 80° C. | 100° C. | 120° C. | 150° C. |
| WITHOUT | | | | |
| COATING | | | | |
| SURFACE | 37° C. | 41° C. | 43° C. | 45° C. |
| HAVING 3 MM | | | | |
| COATING | | | | |
| THICKNESS | | | | |
| SURFACE | 35° C. | 38° C. | 40° C. | 43° C. |
| HAVING 5 MM | | | | |
| COATING | | | | |
| THICKNESS | | | | |

When the data in Table 1 is examined, it has been observed that while the surface temperature of the material where no coating material is applied is 80° C., the surface temperature of the material where 3 mm coating material is applied has decreased to 37° C. In this form, it has been observed that the amount of thermal energy, coming onto the surface of the material where coating material is applied, has reduced.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

1. A coating material capable of providing thermal insulation of a plurality of surfaces and reducing solar or other thermal energy causing negative effects on technological equipment and structures treated with the coating material wherein said coating material comprises following components:
acrylic emulsion at a value between 35% and 45% by weight
silicon dioxide at the value of 0.5% to 1.5% by weight, wherein silicon dioxide provides thickening and strengthening properties;
asbestos wool at the value of 2% to 5% by weight, wherein asbestos wool enables increased resistance to heat, fire, and acids;
opaque polymer component at the value of 6% to 10% by weight, wherein opaque polymer component reduces an amount of binder and increases scrubbing resistance and gloss;
talcum powder at the value of 6% to 10% by weight, wherein talcum powder enables paint layers to interlock with each other and the plurality of surfaces and enhances a homogeneous appearance;
defoamer at the value of 0.1% to 0.5% by weight, wherein defoamer reduces foaming;
antiseptic component at the value of 0.1% to 0.5% by weight
thinner component at the value of 0.3% to 0.6% by weight
dispersing agent at the value of 0.3% to 0.7% by weight
liquid silicon at the value of 3 to 12% by weight
glass spheres with the value of 8% to 35% by weight and having dimensions of 65 to 115 micrometers, wherein glass spheres provide increased thermal insulation properties;
filler glass at the value of 3% to 15% by weight
polyurethane at the value of 0.2% to 0.5% by weight and
water at a value of 10% to 20% by weight.

2. (canceled)

3. (canceled)

4. (canceled)
